(19) United States
(12) Patent Application Publication
(10) Pub. No.: US 2015/0127454 A1
(43) Pub. Date: May 7, 2015

(54) AUTOMATED ENTITY CLASSIFICATION USING USAGE HISTOGRAMS & ENSEMBLES

(71) Applicant: GLOBYS, INC., Seattle, WA (US)

(72) Inventors: Julie Penzotti, Seattle, WA (US); Courosh Mehanian, Redmond, WA (US); Oliver Downs, Redmond, WA (US); Luca Cazzanti, Sarzana (IT)

(73) Assignee: GLOBYS, INC.

(21) Appl. No.: 14/534,128

(22) Filed: Nov. 5, 2014

Related U.S. Application Data
(60) Provisional application No. 61/900,843, filed on Nov. 6, 2013.

(51) Int. Cl. G06Q 30/02

(52) U.S. Cl. CPC G06Q 30/0251; G06Q 30/0201
USPC 705/14.49

(57) ABSTRACT

Techniques disclosed herein employ entity-activity data expressed in a discrete distribution (histogram) form having one or many dimensions to dynamically classify the entity's usage and/or behavior patterns, where groupings or segmentations of different entities that exhibit similar usage patterns are identified using various approaches, including dimensionality reduction, and/or clustering procedures. A consensus or ensemble clustering may be generated that represents a clustering of clusters, based on subclusterings themselves, and/or any combination of subclusters with entity-activity data to selectively execute a market offering campaign. In one embodiment, the resulting ensemble clusterings enable selective directing of targeted offerings to a telecommunication provider's customers.

### CROSS-REFERENCE TO RELATED APPLICATIONS

This non-provisional patent application claims the benefit at least under 35 U.S.C. §119(e) of U.S. Provisional Patent Application Ser. No. 61/900,843, filed on Nov. 6, 2013, entitled “Automated Entity Classification Using Usage Histograms & Ensembles,” which is incorporated herein by reference.

### TECHNICAL FIELD

The present invention relates generally to providing targeted offerings to at least a telecommunications customer and, more particularly, but not exclusively to applying clustering procedures, ensemble methods, and dimensionality reduction techniques to an entity's activity data that is expressed in a discrete distribution (histogram) form, of one or many dimensions, to dynamically classify the entity's usage/behavior patterns, usable to selectively provide an offering.

### BACKGROUND

The dynamics in today's telecommunications market are placing more pressure than ever on networked services providers to find new ways to compete. With high penetration rates and many services nearing commoditization, many companies have recognized that it is more important than ever to find new ways to bring the full and unique value of the network to their customers. In particular, these companies are seeking new solutions to help them more effectively up-sell and/or cross-sell their products, services, content, and applications, successfully launch new products, and create long-term value in new business models.

One traditional approach for marketing a particular product or service to telecommunications customers includes broadcasting a variety of generic offerings to customers to see which ones are popular. However, providing these mass marketing product offerings to a customer may significantly reduce the likelihood that the product will be purchased. It may also result in marketing overload for a customer. Therefore many vendors seek better approaches to marketing their products to their customers. Some approaches include performing various types of analysis on their customer data to try to better understand a customer's needs. However, the data from a telecommunications provider is often very heterogeneous. A large number of different analyses can be carried out, each of which provides a different view of the customer base. Conducting meaningful analysis with a multitude of views on such heterogeneous data may be challenging. Therefore, it is with respect to these considerations and others that the present invention has been made.

### BRIEF DESCRIPTION OF THE DRAWINGS

Non-limiting and non-exhaustive embodiments are described with reference to the following drawings. In the drawings, like reference numerals refer to like parts throughout the various figures unless otherwise specified.

For a better understanding, reference will be made to the following Detailed Description, which is to be read in association with the accompanying drawings, wherein:

FIG. 1 is a system diagram of one embodiment of an environment in which the techniques may be practiced;

FIG. 2 shows one embodiment of a client device that may be included in a system implementing the techniques;

FIG. 3 shows one embodiment of a network device that may be included in a system implementing the techniques;

FIG. 4 shows one embodiment of a contextual marketing architecture using usage histogram-based classifiers;

FIG. 5 shows one embodiment of a flow diagram of a process for employing results from a plurality of clusterings of customer data to selectively market an offering to a customer;

FIG. 6 shows one embodiment of a flow diagram of a process for performing usage histogram-based customer behavior segmentation/clustering;

FIG. 7 shows one embodiment of a flow diagram of a process of performing frontend processing within the process of FIG. 6;

FIG. 8 illustrates a non-limiting, non-exhaustive example of the results of performing the frontend processing on simulated data based on actions from the process of FIG. 6;

FIG. 9 shows one embodiment of aggregating coefficients;

FIG. 10 illustrates a non-limiting, non-exhaustive example of dimensionality reduction for selective customer data;

FIG. 11 shows one embodiment of a flow diagram of a process of training the segmentation model within the process of FIG. 6;

FIG. 12 shows one embodiment of a flow diagram of a process of performing data scoring within the process of FIG. 6;

FIG. 13 illustrates a non-limiting, non-exhaustive example of employing the usage histogram-based behavioral segmentation to telecommunications data, specifically the duration of outbound calls by a customer;

FIG. 14 illustrates a non-limiting, non-exhaustive example of employing the combining of segmentation results from multiple clusterings and using ensemble methods to obtain a consensus clustering; and

FIGS. 15A-15B illustrates a non-limiting, non-exhaustive example of employing the time-series-based behavioral segmentation to dynamically determine market offerings to one of the behavioral segments shown in FIG. 13.

### DETAILED DESCRIPTION

The present techniques now will be described more fully hereinafter with reference to the accompanying drawings, which form a part hereof, and which show, by way of illustration, specific embodiments by which the invention may be practiced. This invention may, however, be embodied in many different forms and should not be construed as limited to the embodiments set forth herein; rather, these embodiments are provided so that this disclosure will be thorough and complete, and will fully convey the scope of the invention to those skilled in the art. Among other things, the present invention may be embodied as methods or devices. Accordingly, the present invention may take the form of an entirely hardware embodiment, an entirely software embodiment or an embodiment combining software and hardware aspects. The following detailed description is, therefore, not to be taken in a limiting sense.

Throughout the specification and claims, the following terms take the meanings explicitly associated herein, unless the context clearly dictates otherwise. The various occurrences of the phrase “in one embodiment” as used herein do not necessarily refer to the same embodiment, though they may. As used herein, the term “or” is an inclusive “or” operator, and is equivalent to the term “and/or,” unless the context clearly dictates otherwise. The term “based on” is not exclusive and allows for being based on additional factors not described, unless the context clearly dictates otherwise. In addition, throughout the specification, the meaning of “a,” “an,” and “the” include plural references. The meaning of “in” includes “in” and “on.”

As used herein, the terms “customer” and “subscriber” may be used interchangeably to refer to an entity that has or is predicted to in the future make a procurement of a product, service, content, and/or application from another entity. As such, customers include not just an individual but also businesses, organizations, or the like. Further, as used herein, the term “entity” refers to a customer, subscriber, or the like.

As used herein, the terms “networked services provider”, “telecommunications”, “telecom”, “provider”, “carrier”, and “operator” may be used interchangeably to refer to a provider of any network-based telecommunications media, product, service, content, and/or application, whether inclusive of or independent of the physical transport medium that may be employed by the telecommunications media, products, services, content, and/or application. As used herein, references to “products/services,” or the like, are intended to include products, services, content, and/or applications, and is not to be construed as being limited to merely “products and/or services.” Further, such references may also include scripts, or the like.

As used herein, the terms “optimized” and “optimal” refer to a solution that is determined to provide a result that is considered closest to a defined criteria or boundary given one or more constraints to the solution. Thus, a solution is considered optimal if it provides the most favorable or desirable result, under some restriction, compared to other determined solutions. An optimal solution therefore, is a solution selected from a set of determined solutions.

As used herein, the term “cluster” refers to a set of objects grouped in such a way so that the objects in one “cluster” or grouping are determined to be more similar (based on some criterion) to each other object within the same “cluster” than to those objects in another grouping or “clustering.” Clusters may also be referred herein to as “segments,” or “segmentations.” It should be noted that clustering may also be based on a dissimilarity measure rather than a similarity measure. Further, as used herein, the actions of grouping the objects is referred to as “clustering.” Clustering may be performed on a result of a prior clustering action. Such clustering of clusters may be referred to herein as “clustering of cluster,” “overarching clustering,” or “ensemble clustering.” Moreover, clustering of clusters (ensemble clustering) need not apply clustering actions merely to clusters, and may also be performed upon a combination of clusters and ‘raw data’ (unclustered data), as well. Such ensemble clustering is directed towards, as described further below, performing clustering that is joint over the sub clusterings (and optionally the raw data), to uniquely discover statistically meaningful dimensions of the data that may subsequently be used to selectively market offerings to the customers represented by the raw data.

As used herein, the terms “offer” and “offering” refer to a networked services provider's product, service, content, and/or application for purchase by a customer. An offer or offering may be presented to the customer using any of a variety of mechanisms. Thus, the offer or offering is independent of the mechanism by which the offer or offering is presented.

The following briefly describes the embodiments in order to provide a basic understanding of some aspects of the techniques. This brief description is not intended as an extensive overview. It is not intended to identify key or critical elements, or to delineate or otherwise narrow the scope. Its purpose is merely to present some concepts in a simplified form as a prelude to the more detailed description that is presented later.

Briefly stated, embodiments are disclosed herein that employ entity-activity data that may be expressed in a discrete distribution (histogram) form having one or many dimensions to dynamically classify the entity's usage and/or behavior patterns. In some embodiments, groupings or segmentations of different entities that exhibit similar usage patterns are identified using various approaches, including dimensionality reduction techniques, and/or unsupervised (or supervised) model-based clustering. An overarching clustering or ensemble clustering may be performed that represents a clustering of clusters. In some embodiments, the sub clusterings themselves, and/or any combination of sub clusters with entity-activity data (raw data) may be employed to generate insights on usage and behaviors usable to selectively execute a market offering campaign. In one embodiment, the resulting ensemble clusterings enable selective directing of offerings to a telecommunication provider's customers.

Data about telecommunication customers, or other entities, are received, where the data represents entities' activity within a specified time window. Information obtained from the entities' behavior may be recorded as usage histograms within their respective time windows. Histogram embodiments may be one-dimensional or multi-dimensional. Entities determined to exhibit similar usage patterns are grouped together using any of a variety of clustering techniques. One embodiment employs a k-means clustering technique; however, another embodiment may employ model-based clustering techniques. Some embodiments disclosed herein include reducing the dimensionality of the histogram through, for example, matrix factorization techniques. Some embodiments combine the segmentation results from multiple clusterings using ensemble methods to obtain a consensus or overarching clustering. As noted above, such overarching clustering may also be performed with a combination of clusterings and raw data. The clustering may be carried out on a set of entity usage profiles referred to as a training set. The groupings determined through the clustering technique may be recorded and applied to entity activity profiles that are not part of the training set. Clustering of entities enables focused marketing based on similar characteristics of members in the cluster.

It is noted that many of the conventional segmentation mechanisms used previous to the current invention tend to key on static, average attributes for an entity. Such mechanisms however often provide a limited snapshot on which to base a grouping of entities. Therefore, embodiments described herein are directed towards addressing such deficiencies by including usage patterns that are intended to capture a profile of an entity's actual usage over time. Thus as disclosed, dynamic classifications of entities are performed making it possible to capture changes in an entity's behavior that static or average attributes may miss. Further, as described, various embodiments are directed towards permitting discovery of incompatibilities between static attributes and actual behavior. In the context of customer segmentation, this capability can be used to selectively provide recommended selections or offerings to better match a customer's actions.

It is noted that while embodiments here disclose applications to telecommunications customers, where the customers are different from the telecommunications providers, other intermediate entities may also benefit from the subject innovations disclosed herein. For example, banking industries, cable television industries, retailers, wholesalers, or virtually any other industry in which that industry's customers interact with the services and/or products offered by an entity within that industry.

### Illustrative Operating Environment

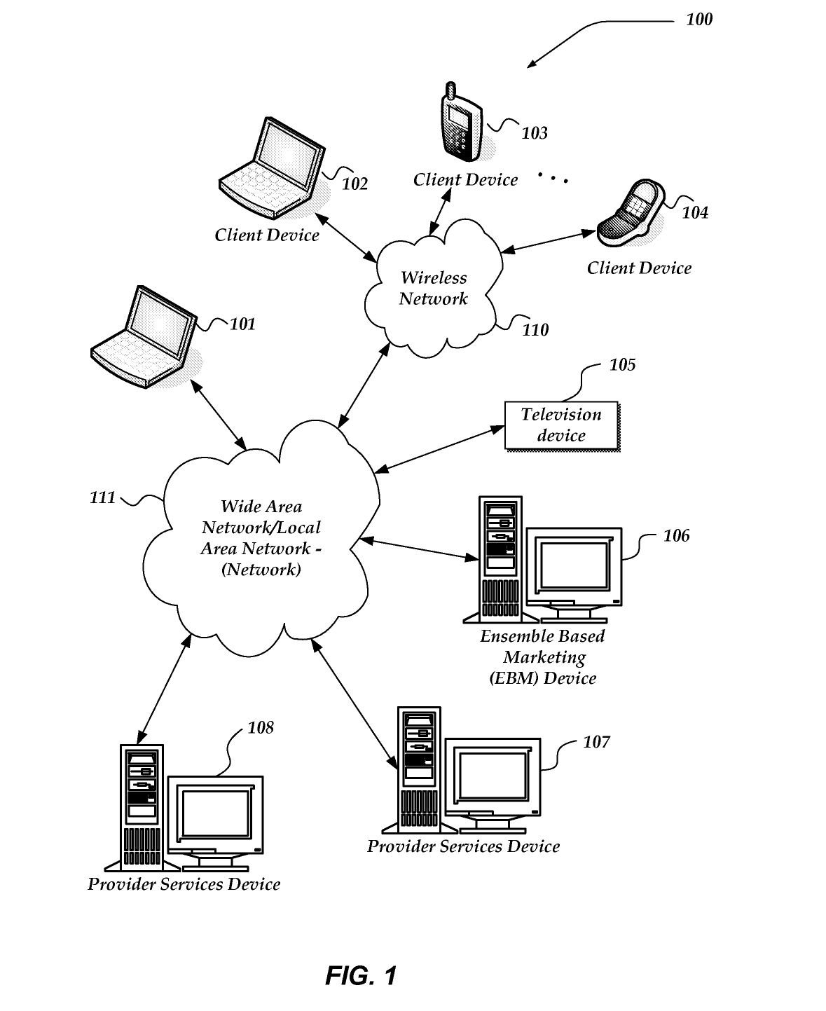

FIG. 1 shows components of one embodiment of an environment in which the invention may be practiced. Not all the components may be required to practice the invention, and variations in the arrangement and type of the components may be made without departing from the spirit or scope of the subject innovations. As shown, system 100 of FIG. 1 includes local area networks (“LANs”)/wide area networks (“WANs”)−(network) 111, wireless network 110, client devices 101-105, Ensemble Based Marketing (EBM) device 106, and provider services 107-108.

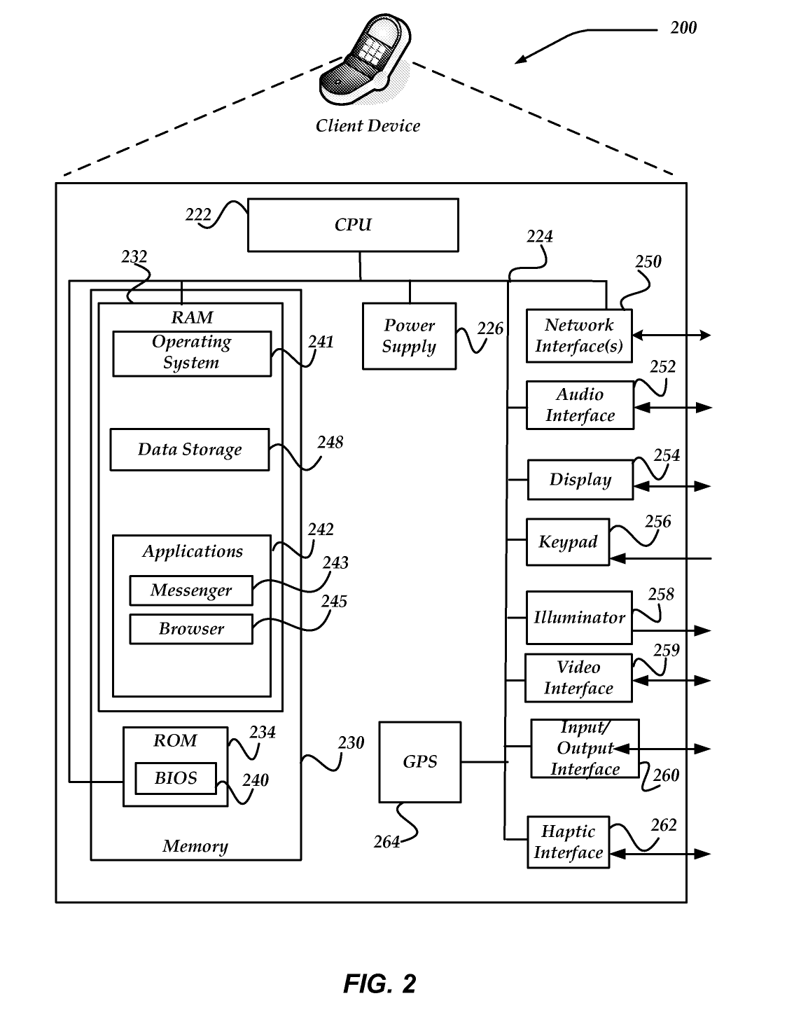

One embodiment of a client device usable as one of client devices 101-105 is described in more detail below in conjunction with FIG. 2. Generally, however, client devices 102-104 may include virtually any computing device capable of receiving and sending a message over a network, such as wireless network 110, wired networks, satellite networks, virtual networks, or the like. Such devices include wireless devices such as, cellular telephones, smart phones, display pagers, radio frequency (RF) devices, infrared (IR) devices, Personal Digital Assistants (PDAs), handheld computers, laptop computers, wearable computers, tablet computers, integrated devices combining one or more of the preceding devices, or the like. Client device 101 may include virtually any computing device that typically connects using a wired communications medium such as telephones, televisions, video recorders, cable boxes, gaming consoles, personal computers, multiprocessor systems, microprocessor-based or programmable consumer electronics, network PCs, or the like. Further, as illustrated, client device 105 represents one embodiment of a client device operable as a television device. In one embodiment, one or more of client devices 101-105 may also be configured to operate over a wired and/or a wireless network.

Client devices 101-105 typically range widely in terms of capabilities and features. For example, a cell phone may have a numeric keypad and a few lines of monochrome LCD display on which only text may be displayed. In another example, a web-enabled client device may have a touch sensitive screen, a stylus, and several lines of color display in which both text and graphics may be displayed.

A web-enabled client device may include a browser application that is configured to receive and to send web pages, web-based messages, or the like. The browser application may be configured to receive and display graphics, text, multimedia, or the like, employing virtually any web-based language, including a wireless application protocol messages (WAP), or the like. In one embodiment, the browser application is enabled to employ Handheld Device Markup Language (HDML), Wireless Markup Language (WML), WMLScript, JavaScript, Standard Generalized Markup Language (SMGL), HyperText Markup Language (HTML), eXtensible Markup Language (XML), or the like, to display and send information.

Client devices 101-105 also may include at least one other client application that is configured to receive information and other data from another computing device. The client application may include a capability to provide and receive textual content, multimedia information, or the like. The client application may further provide information that identifies itself, including a type, capability, name, or the like. In one embodiment, client devices 101-105 may uniquely identify themselves through any of a variety of mechanisms, including a phone number, Mobile Identification Number (MIN), an electronic serial number (ESN), mobile device identifier, network address, or other identifier. The identifier may be provided in a message, or the like, sent to another computing device.

In one embodiment, client devices 101-105 may further provide information useable to detect a location of the client device. Such information may be provided in a message, or sent as a separate message to another computing device.

Client devices 101-105 may also be configured to communicate a message, such as through email, Short Message Service (SMS), Multimedia Message Service (MMS), instant messaging (IM), internet relay chat (IRC), Mardam-Bey's IRC (mIRC), Jabber, or the like, between another computing device. However, the present invention is not limited to these message protocols, and virtually any other message protocol may be employed.

Client devices 101-105 may further be configured to include a client application that enables the user to log into a user account that may be managed by another computing device.

Information provided either as part of a user account generation, a purchase, or other activity may result in providing various customer profile information. Such customer profile information may include, but is not limited to purchase history, current telecommunication plans about a customer, and/or behavioral information about a customer and/or a customer's activities.

Wireless network 110 is configured to couple client devices 102-104 with network 111. Wireless network 110 may include any of a variety of wireless sub-networks that may further overlay stand-alone ad-hoc networks, or the like, to provide an infrastructure-oriented connection for client devices 102-104. Such sub-networks may include mesh networks, Wireless LAN (WLAN) networks, cellular networks, or the like.

Wireless network 110 may further include an autonomous system of terminals, gateways, routers, or the like connected by wireless radio links, or the like. These connectors may be configured to move freely and randomly and organize themselves arbitrarily, such that the topology of wireless network 110 may change rapidly.

Wireless network 110 may further employ a plurality of access technologies including 2nd (2G), 3rd (3G), 4th (4G) generation radio access for cellular systems, WLAN, Wireless Router (WR) mesh, or the like. Access technologies such as 2G, 2.5G, 3G, 4G, and future access networks may enable wide area coverage for client devices, such as client devices 102-104 with various degrees of mobility. For example, wireless network 110 may enable a radio connection through a radio network access such as Global System for Mobile communication (GSM), General Packet Radio Services (GPRS), Enhanced Data GSM Environment (EDGE), Wideband Code Division Multiple Access (WCDMA), Bluetooth, or the like. In essence, wireless network 110 may include virtually any wireless communication mechanism by which information may travel between client devices 102-104 and another computing device, network, or the like.

Network 111 couples EBM device 106, provider service devices 107-108, and client devices 101 and 105 with other computing devices, and allows communications through wireless network 110 to client devices 102-104. Network 111 is enabled to employ any form of computer readable media for communicating information from one electronic device to another. Also, network 111 can include the Internet in addition to local area networks (LANs), wide area networks (WANs), direct connections, such as through a universal serial bus (USB) port, other forms of computer-readable media, or any combination thereof. On an interconnected set of LANs, including those based on differing architectures and protocols, a router may act as a link between LANs, enabling messages to be sent from one to another. In addition, communication links within LANs typically include twisted wire pair or coaxial cable, while communication links between networks may utilize analog telephone lines, full or fractional dedicated digital lines including T1, T2, T3, and T4, Integrated Services Digital Networks (ISDNs), Digital Subscriber Lines (DSLs), wireless links including satellite links, or other communications links known to those skilled in the art. Furthermore, remote computers and other related electronic devices could be remotely connected to either LANs or WANs via a modem and temporary telephone link. In essence, network 111 includes any communication method by which information may travel between computing devices.

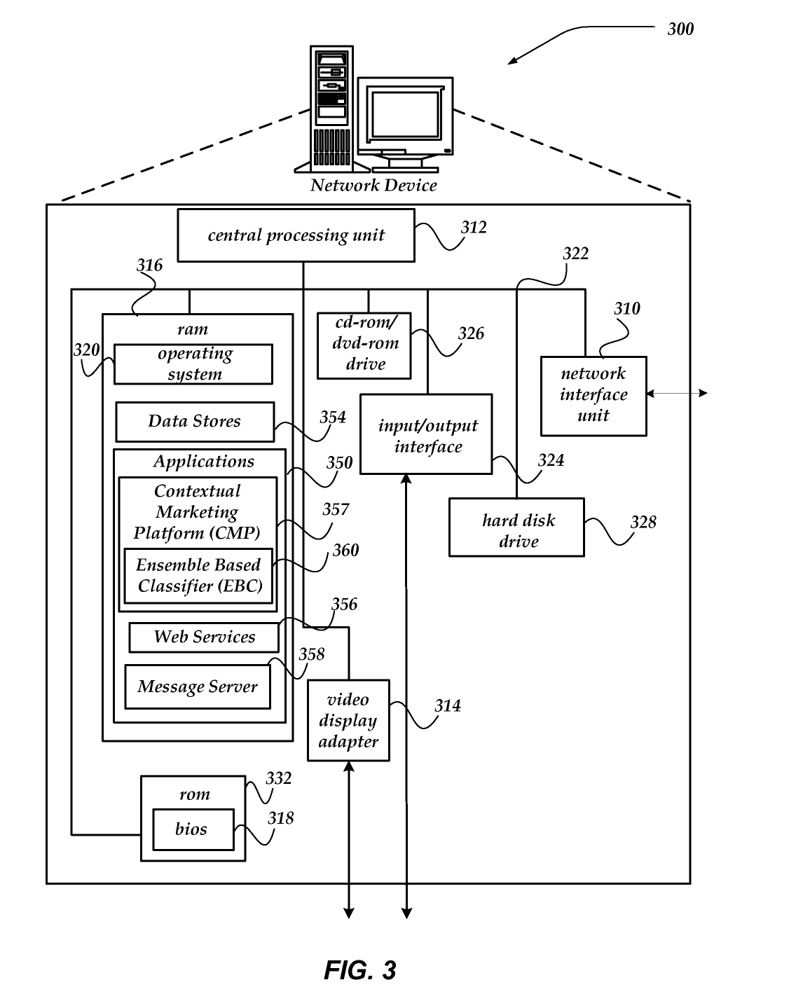

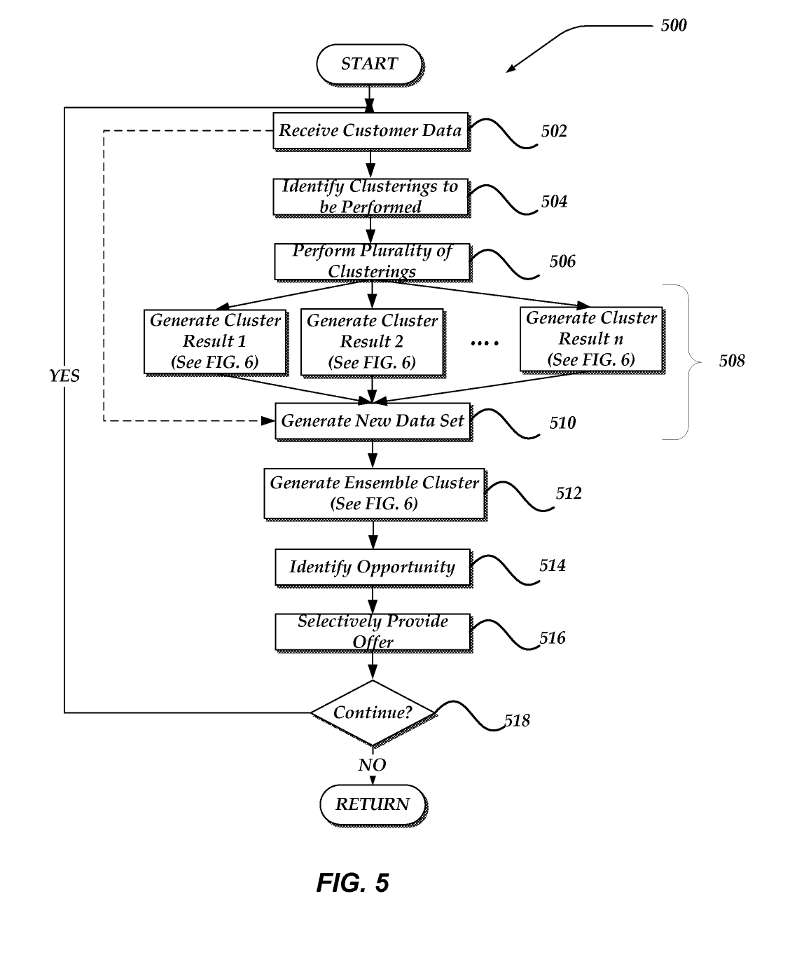

One embodiment of an EBM device 106 is described in more detail below in conjunction with FIG. 3. Briefly, however, EBM device 106 includes virtually any network computing device that is configured to proactively and contextually target offers to customers based on usage histogram-based entity behavior classifications as described in more detail below in conjunction with FIG. 5.

Devices that may operate as EBM device 106 include, but are not limited to personal computers, desktop computers, multiprocessor systems, microprocessor-based or programmable consumer electronics, network PCs, servers, network appliances, and the like.

Although EBM device 106 is illustrated as a distinct network device, the invention is not so limited. For example, a plurality of network devices may be configured to perform the operational aspects of EBM device 106. For example, data collection might be performed by one or more set of network devices, while entity behavior classifications, and/or reporting interfaces, and/or the like, might be provided by one or more other network devices.

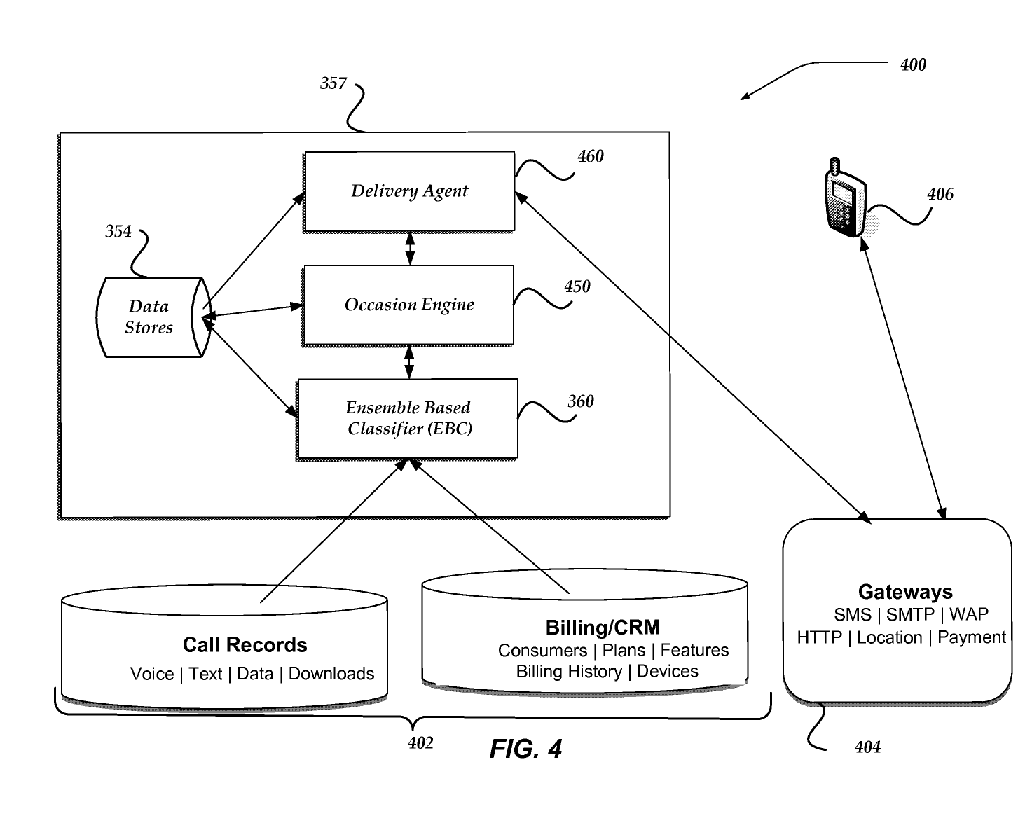

Provider service devices 107-108 include virtually any network computing device that is configured to provide to EBM device 106 information including networked services provider information, customer information, and/or other context information for use in generating and selectively pushing or otherwise presenting a customer with targeted customer offers. In some embodiments, provider service devices 107-108 may provide various interfaces, including, but not limited to those described in more detail below in conjunction with FIG. 4.

### Illustrative Client Environment

FIG. 2 shows one embodiment of client device 200 that may be included in a system implementing the invention. Client device 200 may include many more or less components than those shown in FIG. 2. However, the components shown are sufficient to disclose an illustrative embodiment for practicing the present invention. Client device 200 may represent, for example, one of client devices 101-105 of FIG. 1.

As shown in the figure, client device 200 includes a processing unit (CPU) 222 in communication with a mass memory 230 via a bus 224. Client device 200 also includes a power supply 226, one or more network interfaces 250, an audio interface 252, video interface 259, a display 254, a keypad 256, an illuminator 258, an input/output interface 260, a haptic interface 262, and an optional global positioning systems (GPS) receiver 264. Power supply 226 provides power to client device 200. A rechargeable or non-rechargeable battery may be used to provide power. The power may also be provided by an external power source, such as an AC adapter or a powered docking cradle that supplements and/or recharges a battery.

Client device 200 may optionally communicate with a base station (not shown), or directly with another computing device. Network interface 250 includes circuitry for coupling client device 200 to one or more networks, and is constructed for use with one or more communication protocols and technologies including, but not limited to, global system for mobile communication (GSM), code division multiple access (CDMA), time division multiple access (TDMA), user datagram protocol (UDP), transmission control protocol/Internet protocol (TCP/IP), SMS, general packet radio service (GPRS), WAP, ultra wide band (UWB), IEEE 802.16 Worldwide Interoperability for Microwave Access (WiMax), SIP/RTP, Bluetooth™, infrared, Wi-Fi, Zigbee, or any of a variety of other wireless communication protocols. Network interface 250 is sometimes known as a transceiver, transceiving device, or network interface card (NIC).

Audio interface 252 is arranged to produce and receive audio signals such as the sound of a human voice. For example, audio interface 252 may be coupled to a speaker and microphone (not shown) to enable telecommunication with others and/or generate an audio acknowledgement for some action. Display 254 may be a liquid crystal display (LCD), gas plasma, light emitting diode (LED), or any other type of display used with a computing device. Display 254 may also include a touch sensitive screen arranged to receive input from an object such as a stylus or a digit from a human hand.

Video interface 259 is arranged to capture video images, such as a still photo, a video segment, an infrared video, or the like. For example, video interface 259 may be coupled to a digital video camera, a web-camera, or the like. Video interface 259 may comprise a lens, an image sensor, and other electronics. Image sensors may include a complementary metal-oxide-semiconductor (CMOS) integrated circuit, charge-coupled device (CCD), or any other integrated circuit for sensing light.

Keypad 256 may comprise any input device arranged to receive input from a user. For example, keypad 256 may include a push button numeric dial, or a keyboard. Keypad 256 may also include command buttons that are associated with selecting and sending images. Illuminator 258 may provide a status indication and/or provide light. Illuminator 258 may remain active for specific periods of time or in response to events. For example, when illuminator 258 is active, it may backlight the buttons on keypad 256 and stay on while the client device is powered. Also, illuminator 258 may backlight these buttons in various patterns when particular actions are performed, such as dialing another client device. Illuminator 258 may also cause light sources positioned within a transparent or translucent case of the client device to illuminate in response to actions.

Client device 200 also comprises input/output interface 260 for communicating with external devices, such as a headset, or other input or output devices not shown in FIG. 2. Input/output interface 260 can utilize one or more communication technologies, such as USB, infrared, Bluetooth™, Wi-Fi, Zigbee, or the like. Haptic interface 262 is arranged to provide tactile feedback to a user of the client device. For example, the haptic interface may be employed to vibrate client device 200 in a particular way when another user of a computing device is calling.

Optional GPS transceiver 264 can determine the physical coordinates of client device 200 on the surface of the Earth, which typically outputs a location as latitude and longitude values. GPS transceiver 264 can also employ other geo-positioning mechanisms, including, but not limited to, triangulation, assisted GPS (AGPS), E-OTD, CI, SAI, ETA, BSS or the like, to further determine the physical location of client device 200 on the surface of the Earth. It is understood that under different conditions, GPS transceiver 264 can determine a physical location within millimeters for client device 200; and in other cases, the determined physical location may be less precise, such as within a meter or significantly greater distances. In one embodiment, however, a client device may through other components, provide other information that may be employed to determine a physical location of the device, including for example, a MAC address, IP address, or the like.

Mass memory 230 includes a RAM 232, a ROM 234, and other storage means. Mass memory 230 illustrates another example of computer readable storage media for storage of information such as computer readable instructions, data structures, program modules, or other data. Computer readable storage media may include volatile, nonvolatile, removable, and non-removable media implemented in any method or technology for storage of information, such as computer readable instructions, data structures, program modules, or other data. Examples of computer storage media include RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can be accessed by a computing device.

Mass memory 230 stores a basic input/output system (“BIOS”) 240 for controlling low-level operation of client device 200. The mass memory also stores an operating system 241 for controlling the operation of client device 200. It will be appreciated that this component may include a general-purpose operating system such as a version of UNIX, or LINUX™, or a specialized client operating system, for example, such as Windows Mobile™, PlayStation 3 System Software, the Symbian® operating system, or the like. The operating system may include, or interface with a Java virtual machine module that enables control of hardware components and/or operating system operations via Java application programs.

Memory 230 further includes one or more data storage 248, which can be utilized by client device 200 to store, among other things, applications 242 and/or other data. For example, data storage 248 may also be employed to store information that describes various capabilities of client device 200, as well as store an identifier. The information, including the identifier, may then be provided to another device based on any of a variety of events, including being sent as part of a header during a communication, sent upon request, or the like. In one embodiment, the identifier and/or other information about client device 200 might be provided automatically to another networked device, independent of a directed action to do so by a user of client device 200. Thus, in one embodiment, the identifier might be provided over the network transparent to the user.

Moreover, data storage 248 may also be employed to store personal information including but not limited to contact lists, personal preferences, purchase history information, user demographic information, behavioral information, or the like. At least a portion of the information may also be stored on a disk drive or other storage medium (not shown) within client device 200.

Applications 242 may include computer executable instructions which, when executed by client device 200, transmit, receive, and/or otherwise process messages (e.g., SMS, MMS, IM, email, and/or other messages), multimedia information, and enable telecommunication with another user of another client device. Other examples of application programs include calendars, browsers, email clients, IM applications, SMS applications, VOIP applications, contact managers, task managers, transcoders, database programs, word processing programs, security applications, spreadsheet programs, games, search programs, and so forth. Applications 242 may include, for example, messenger 243, and browser 245.

Browser 245 may include virtually any client application configured to receive and display graphics, text, multimedia, and the like, employing virtually any web based language. In one embodiment, the browser application is enabled to employ Handheld Device Markup Language (HDML), Wireless Markup Language (WML), WMLScript, JavaScript, Standard Generalized Markup Language (SMGL), HyperText Markup Language (HTML), eXtensible Markup Language (XML), and the like, to display and send a message. However, any of a variety of other web-based languages may also be employed.

Messenger 243 may be configured to initiate and manage a messaging session using any of a variety of messaging communications including, but not limited to email, Short Message Service (SMS), Instant Message (IM), Multimedia Message Service (MMS), internet relay chat (IRC), mIRC, and the like. For example, in one embodiment, messenger 243 may be configured as an IM application, such as AOL Instant Messenger, Yahoo! Messenger, .NET Messenger Server, ICQ, or the like. In one embodiment messenger 243 may be configured to include a mail user agent (MUA) such as Elm, Pine, MH, Outlook, Eudora, Mac Mail, Mozilla Thunderbird, or the like. In another embodiment, messenger 243 may be a client application that is configured to integrate and employ a variety of messaging protocols. Messenger 243 and/or browser 245 may be employed by a user of client device 200 to receive selectively targeted offers of a product/service based on entity behavior classifications.

### Illustrative Network Device Environment

FIG. 3 shows one embodiment of a network device, according to one embodiment of the invention. Network device 300 may include many more components than those shown. The components shown, however, are sufficient to disclose an illustrative embodiment for practicing the invention. Network device 300 may represent, for example, EBM device 106 of FIG. 1.

Network device 300 includes processing unit 312, video display adapter 314, and a mass memory, all in communication with each other via bus 322. The mass memory generally includes RAM 316, ROM 332, and one or more permanent mass storage devices, such as hard disk drive 328, tape drive, optical drive, and/or floppy disk drive. The mass memory stores operating system 320 for controlling the operation of network device 300. Any general-purpose operating system may be employed. Basic input/output system (“BIOS”) 318 is also provided for controlling the low-level operation of network device 300. As illustrated in FIG. 3, network device 300 also can communicate with the Internet, or some other communications network, via network interface unit 310, which is constructed for use with various communication protocols including the TCP/IP protocol. Network interface unit 310 is sometimes known as a transceiver, transceiving device, or network interface card (NIC).

The mass memory as described above illustrates another type of computer-readable device, namely computer storage devices. Computer readable storage devices may include volatile, nonvolatile, removable, and non-removable media implemented in any method or technology for storage of information, such as computer readable instructions, data structures, program modules, or other data. Examples of computer storage media include RAM, ROM, EEPROM, flash memory or other memory technology, CD-ROM, digital versatile disks (DVD) or other optical storage, magnetic cassettes, magnetic tape, magnetic disk storage or other magnetic storage devices, or any other non-transitory, physical devices which can be used to store the desired information and which can be accessed by a computing device.

The mass memory also stores program code and data. For example, mass memory might include data store 354. Data store 354 may be include virtually any mechanism usable for store and managing data, including but not limited to a file, a folder, a document, or an application, such as a database, spreadsheet, or the like. Data store 354 may manage information that might include, but is not limited to web pages, information about members to a social networking activity, contact lists, identifiers, profile information, tags, labels, or the like, associated with a user, as well as scripts, applications, applets, and the like.

One or more applications 350 may be loaded into mass memory and run on operating system 320. Examples of application programs may include transcoders, schedulers, calendars, database programs, word processing programs, HTTP programs, customizable user interface programs, IPSec applications, encryption programs, security programs, VPN programs, web servers, account management, games, media streaming or multicasting, and so forth. Applications 350 may include web services 356, Message Server (MS) 358, and Contextual Marketing Platform (CMP) 357. As shown, CMP 357 includes Ensemble Based Classifier (EBC) 360.

Web services 356 represent any of a variety of services that are configured to provide content, including messages, over a network to another computing device. Thus, web services 356 include for example, a web server, messaging server, a File Transfer Protocol (FTP) server, a database server, a content server, or the like. Web services 356 may provide the content including messages over the network using any of a variety of formats, including, but not limited to WAP, HDML, WML, SMGL, HTML, XML, cHTML, xHTML, or the like. In one embodiment, web services 356 might interact with CMP 357 to enable a networked services provider to track customer behavior, and/or provide contextual offerings based on an ensemble clusterings of usage histogram-based entity behavior classification.

Message server 358 may include virtually any computing component or components configured and arranged to forward messages from message user agents, and/or other message servers, or to deliver messages to a local message store, such as data store 354, or the like. Thus, message server 358 may include a message transfer manager to communicate a message employing any of a variety of email protocols, including, but not limited, to Simple Mail Transfer Protocol (SMTP), Post Office Protocol (POP), Internet Message Access Protocol (IMAP), NNTP, Session Initiation Protocol (SIP), or the like.

However, message server 358 is not constrained to email messages, and other messaging protocols may also be managed by one or more components of message server 358. Thus, message server 358 may also be configured to manage SMS messages, IM, MMS, IRC, mIRC, or any of a variety of other message types. In one embodiment, message server 358 may also be configured to interact with CMP 357 and/or web services 356 to provide various communication and/or other interfaces useable to receive provider, customer, and/or other information useable to determine and/or provide contextual customer offers.

One embodiment of CMP 357 and EBC 360 are described further below in conjunction with FIG. 4. However, briefly, CMP 357 is configured to receive various historical data from networked services providers about their customers, including customer profiles, billing records, usage data, purchase data, types of mobile devices, and the like. CMP 357 may then perform analysis including usage histogram-based entity behavior classifications. In one embodiment, CMP 357 employs entity behavior classifications to identify a plurality of occasions (or contexts) when it may be desirable to interact with any particular customer.

CMP 357 monitors ongoing historical and/or real-time data from the networked services provider or external sources to detect or predict within a combination of a plurality of confidence levels, when an occasion is likely to occur for particular customers. Then, based on a detected or predicted occurrence of an occasion for a customer, CMP 357 may select an offer targeted to the customer. The selected offer may then be presented to the customer. However, in one embodiment, CMP 357 might determine that no offer is to be presented to the customer based in part on none of the available offers having a likelihood of being accepted by the customer that exceeds a given threshold. In this manner, the customer is selectively presented with an offer at a time, location, and in an entity behavior classification defined situation when they are predicted to be most emotionally receptive to the offering, while avoiding sending offers that are likely to not be accepted during the given occasion by the customer. In one embodiment, the given threshold is selected for each customer based on the customer's previous purchases for similar products/services, and the like.

### Illustrative Architecture

FIG. 4 shows one embodiment of an architecture useable to perform contextual occasion marketing for contextual offers to be delivered to the customer based on detection of an occasion occurrence for the customer. Architecture 400 of FIG. 4 may include many more components than those shown. The components shown, however, are sufficient to disclose an illustrative embodiment for practicing the invention. Architecture 400 may be deployed across components of FIG. 1, including, for example, EBM device 106, client devices 101-105, and/or provider services 107-108.

Architecture 400 is configured to make selection decisions from entity behavior classifications of historical networked services provider's customer usage records, billing data, and the like. Occasions are identified based on the analytics, and monitored to identify and/or predict their occurrence for customers. Offers to the customer during the occurrence of an occasion are optimized according to a customer's interests and preferences as determined by the historical data and the nature of the occasion. Each offer is directed to be optimized to resonate with the customer—highly targeted, relevant, and timely. At the same time, in one embodiment, if for a given customer it is determined that no offer is likely to be accepted by the customer for a given occasion, then no offer is delivered to the customer. In this manner, the customer is not overwhelmed with unnecessary and undesired offerings. Such unnecessary offerings might be perceived by the customer as spam, potentially resulting in decreasing receptivity by the customer to future offers.

In any event, not all the components shown in FIG. 4 may be required to practice the invention and variations in the arrangement and type of the components may be made without departing from the spirit or scope of the subject innovation. As shown, however, architecture 400 includes a CMP 357, networked services provider (NSP) data stores 402, communication channel or communication channels 404, and client device 406.

Client device 406 represents a client device, such as client devices 101-105 described above in conjunction with FIGS. 1-2. NSP data stores 402 may be implemented within one or more services 107-108 of FIG. 1. As shown, NSP data stores 402 may include a Billing/Customer Relationship Management (CRM) data store, and a Network Usage Records data store. However, the subject innovation is not limited to this information, and other types of data from networked services providers may also be used. The Billing/CRM data may be configured to provide such historical data as a customer's profile, including their billing history, customer service plan information, service subscriptions, feature information, content purchases, client device characteristics, and the like. Usage Records may provide various historical data including but not limited to network usage record information including voice, text, internet, download information, media access, and the like. NSP data stores 402 may also provide information about a time when such communications occur, as well as a physical location for which a customer might be connected to during a communication, and information about the entity to which a customer is connecting. Such physical location information may be determined using a variety of mechanisms, including for example, identifying a cellular station that a customer is connected to during the communication. From such connection location information, an approximate geographic or relative location of the customer may be determined.

CMP 357 is streamlined for occasion identification and presentation. Only a small percentage of the massive amount of incoming data might be processed immediately. The remaining records may be processed from a buffer to take advantage of processing power efficiently over a full 24 hours. As the raw data is processed into predictive scores, times, statistics and other supporting data, it may be discarded from the system, in one embodiment, leaving a sustainable data set that scales as a function of consumer base.

Communication channels 404 include one or more components that are configured to enable network devices to deliver and receive interactive communications with a customer. In one embodiment, communication channels 404 may be implemented within one or more of provider services 107-108, and/or client devices 101-105 of FIG. 1, and/or within networks 110 and/or 111 of FIG. 1.

The various components of CMP 357 are described further below. Briefly, however, CMP 357 is configured to receive customer data from NSP data stores 402. CMP 357 may then employ Ensemble Based classifier (EBC) 360 to classify entities. CMP 357 may further use then employ the results of the entity based classifications within occasions engine 450 to determine to whom and when to provide an offering to a customer. The results of occasions engine 450 may be provided to a customer through deliver agent 460.

The following sections provide more detail on various actions performed at least by EBC 360.

### Generalized Operation

The operation of certain additional general aspects of the subject innovation will now be described with respect to FIGS. 5-12. Actions described in these figures are performed by one or more components within EBM device 106 of FIG. 1.

FIG. 5 shows one embodiment of a flow diagram of a process for performing ensemble based clustering using usage histogram-based customer behavior segmentation to provide an offering to the customer. The process of FIG. 5 may be performed for example by EBC 360 of FIG. 3.

Process 500 of FIG. 5, begins, after a start block, at block 502, where customer data is received. In one embodiment, the customer data is temporal customer data. Briefly, temporal customer data may be used to segment customers in behaviorally similar segments or clusters. Temporal data may include balance, recharge activity, incoming (plus/and/or) outgoing voice activity, incoming (plus/and/or) outgoing SMS activity, data usage, and the like. Further, as discussed above, a small fraction of the total available customer data might be used to train the segmentation models of blocks 508 and/or 512 below. In one embodiment, the clustering techniques might include an unsupervised clustering algorithm. However, in other embodiments supervised clustering may also be employed. Thus, while the non-limiting example below illustrates use of unsupervised clustering, it should be understood that supervised clustering may also be employed with appropriate modifications

Processing next flows to block 504, where a number, n, of clusterings to be performed are identified. In one embodiment, the number of clusterings may be identified (determined) based on a variety of different techniques to be used. In some embodiments, the number of clusters may be determined by the data types which are available to block 502. For example, call data records for voice and/or SMS usage and/or upload and down load data usage sessions may or may not be available in addition to recharge or billing data sets. Usage of these data types may then be used to identify a value for n, the number of clusterings to be performed. In another embodiment, the number of clusterings to be performed may be determined by a user inputting a selection of clusterings to include, such as clusterings relevant for voice usage behaviors may be of interest to a user for a given marketing opportunity, but not SMS usage. By use of a marketing opportunity under evaluation, or based on other evaluations to be considered, n may then be determined. In yet another embodiment, the number of clusterings may be determined by automated statistical criteria applied to the processing flow of blocks 506 and 508. These statistical criteria may include measures of orthogonality of the data types used for generating the n-clusterings or coincidence matrices for entities across the n-clusterings as a measure of the similarity or dissimilarity of the n-clusterings to each other, where the number of clusterings to be performed is managed. It is noted that other mechanisms may be used to determine the number of clusterings to be performed, and thus the above are non-limiting, non-exhaustive examples.

The number of clusterings to be performed at blocks 508 may range into the thousands or even hundreds of thousands of clusterings. Thus, in one embodiment, at block 506n, the number of clusterings, shown as blocks 508 is performed in parallel. However, in other embodiments, at least some of the clusterings in blocks 508 may be performed sequentially.

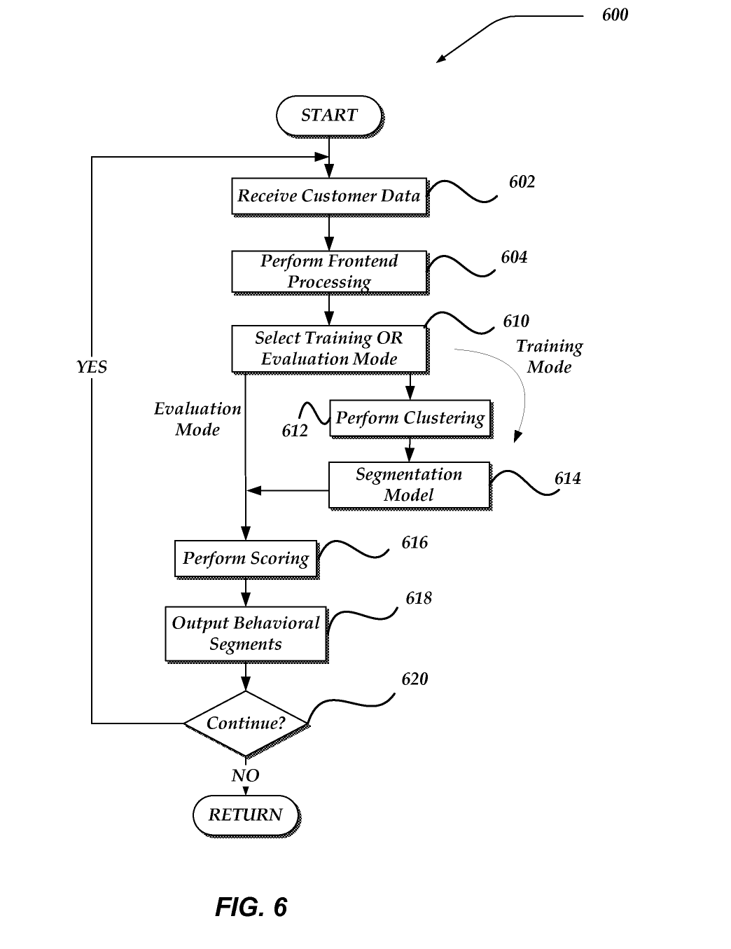

In any event, each of the clusterings actions performed at blocks 508 may be based on different portions of the customer data 502, based on different clustering techniques, or based on any of a variety of other criteria. FIG. 6 shows one embodiment of a flow diagram of a process usable at blocks 508 for performing usage histogram-based clustering to generate n number of clustering results.

The one or more of the clustering results from blocks 508, optionally along with the raw customer data of block 502 may be combined to generate a new data set at block 510. Selection of the subsets of clustering results from blocks 508 may be based on a variety of criteria. For example, similar criteria might be employed as used to determine n. However, in one embodiment, a different threshold criteria might be used, a more refined market opportunity might be explored, or the like. Thus, in some embodiments, a subset of the clustering results of blocks 508 might be fed into block 510. However, in other embodiments, all n clustering results from blocks 508 may be used. In addition to the n-cluster assignments from blocks 508, raw data that may be added to compose the new data set at block 510 may include entity specific data such as age, handset type, geographical area of residence, or may include models based on raw data such as propensities for offer acceptance, churn risks, or so forth. This new data set may then be provided as input to the process 600 of FIG. 6 to generate an ensemble clustering, or clustering of clusterings. That is, resulting process flow applied to the data set at block 510 is used to generate the Ensemble Cluster of block 512.

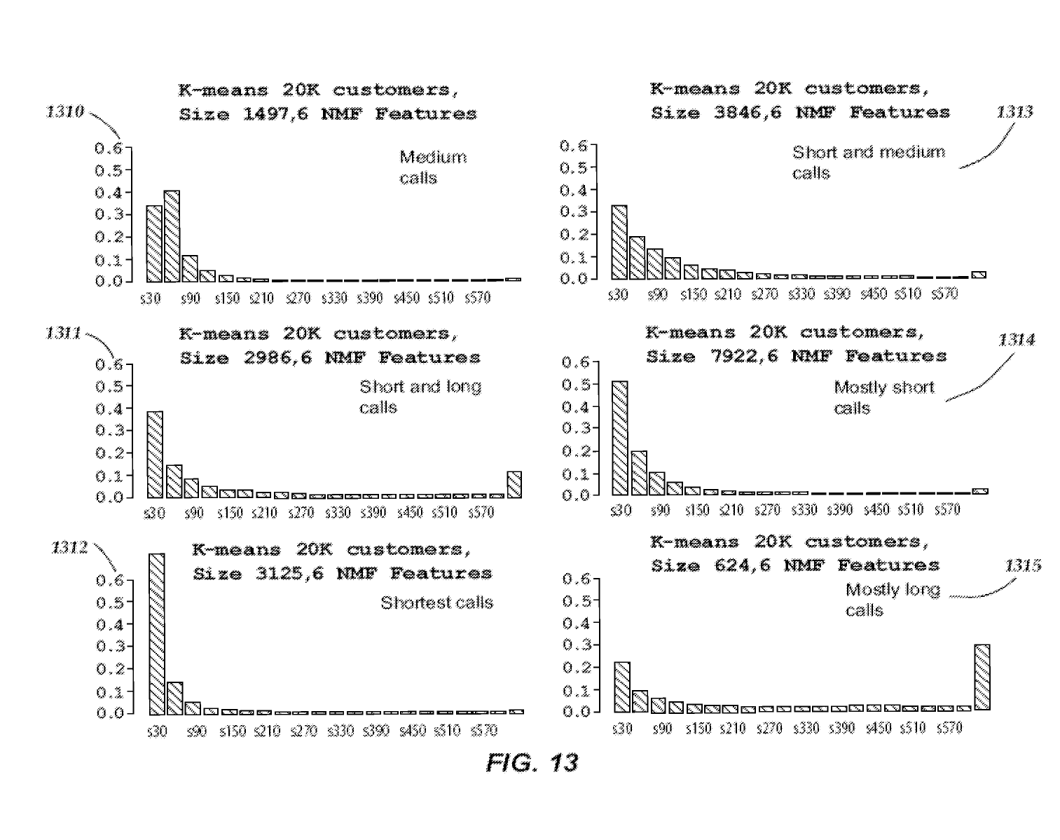

Processing flows next to block 514, where the ensemble clusterings are used to identify an opportunity to provide an offer to one or more customers. Examples of identifying such opportunities are discussed in more detail below in conjunction with FIGS. 13-15(A and B). Then flowing to block 516, an appropriate offer is provided to an identified customer or customers at a determined time, location, and/or using a selected mechanism for transmitting the offer. It should be understood that at blocks 514 and/or 516 a determination may be made that no offering is to be provided, because, in part, it is determined that no offer has a likelihood of being accepted by a customer exceeds a threshold value. Thus, in some situations, no offer is provided to a customer at this time and/or location.

Whether or not an offer is provided to a customer, process 500 then flows to decision block 518, where a determination is made whether to continue to perform entity segmentation using usage histograms and ensembles. If yes, then processing flows back to block 502, where additional customer data may be received. Otherwise, processing may return to a calling process.

FIG. 6 shows one embodiment of a flow diagram of a process for performing usage histogram-based customer behavior segmentation. In one embodiment, process 600 of FIG. 6 represents at least some of the actions that may be performed at blocks 508 and 512 of FIG. 5.

Process 600 of FIG. 6 begins, after a start block, at block 602, where customer data is received. In one embodiment, the customer data received at block 602 may include clustering data such as when process 600 represents ensemble clustering. However, such customer data may also be the raw customer data obtained at block 502 of process 500.

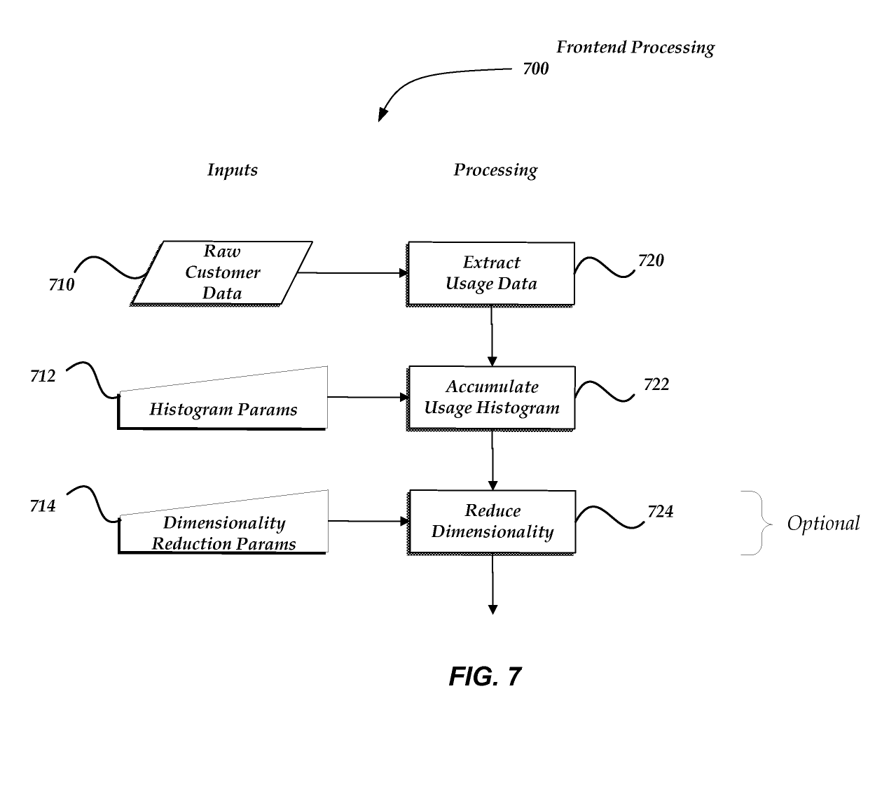

Process 600 flows next to block 604, where frontend processing is performed. Block 604 is described in more detail below in conjunction with process 700 of FIG. 7. Briefly, however, at block 604, particular aspects of customer usage are extracted from the customer data received at block 602 (sometimes also called raw data). A histogram analysis is then performed on the usage data to compute a set of histogram coefficients, or alternatively, matrix-factorized histogram coefficients as described below. The frontend processing block 604 of FIG. 6 may be applied to data from a plurality of customers.

Processing next flows to block 610, where a determination is made whether to train the model using the received data, or to perform a classification of the received data using an evaluation mode. The determination may be based on a variety of criteria, including a switch value, a time period since a previous training was performed, or the like. For example, if no previous training of the model has been performed, then the flow direction of process 600 is to perform the training mode.

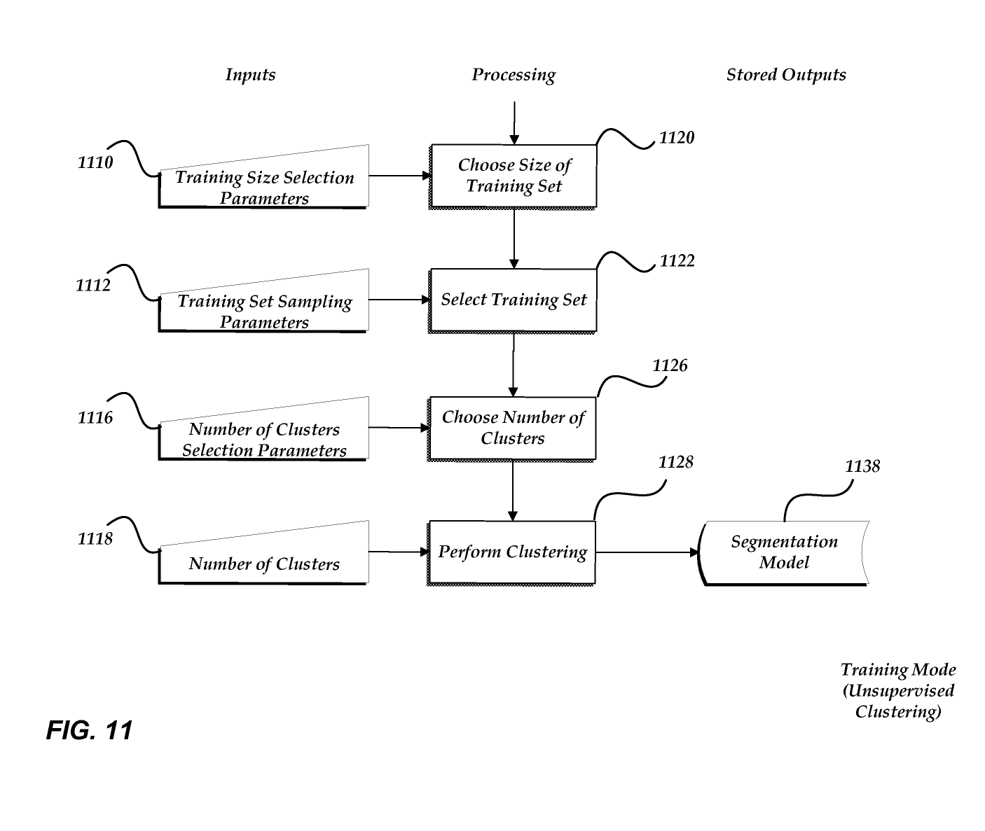

For the training mode, processing continues to blocks 612 and 614, which are described in more detail below in conjunction with FIG. 11. Briefly, at block 612, in one embodiment, an unsupervised clustering of the data is performed using the histogram or non-negative matrix factorization (usually abbreviated NMF) basis coefficients from block 604. At block 614, in one embodiment, the training data is modeled as a Gaussian mixture model that is useable to define a segmentation model.

Moving to block 616, a result of the scoring provides a classification of testing data into one of the established customer segments. In one embodiment, as shown in FIG. 6, frontend processing may be common to both training of the unsupervised clustering, and the classification of unseen data. Thus, FIG. 6 includes both training and classification.

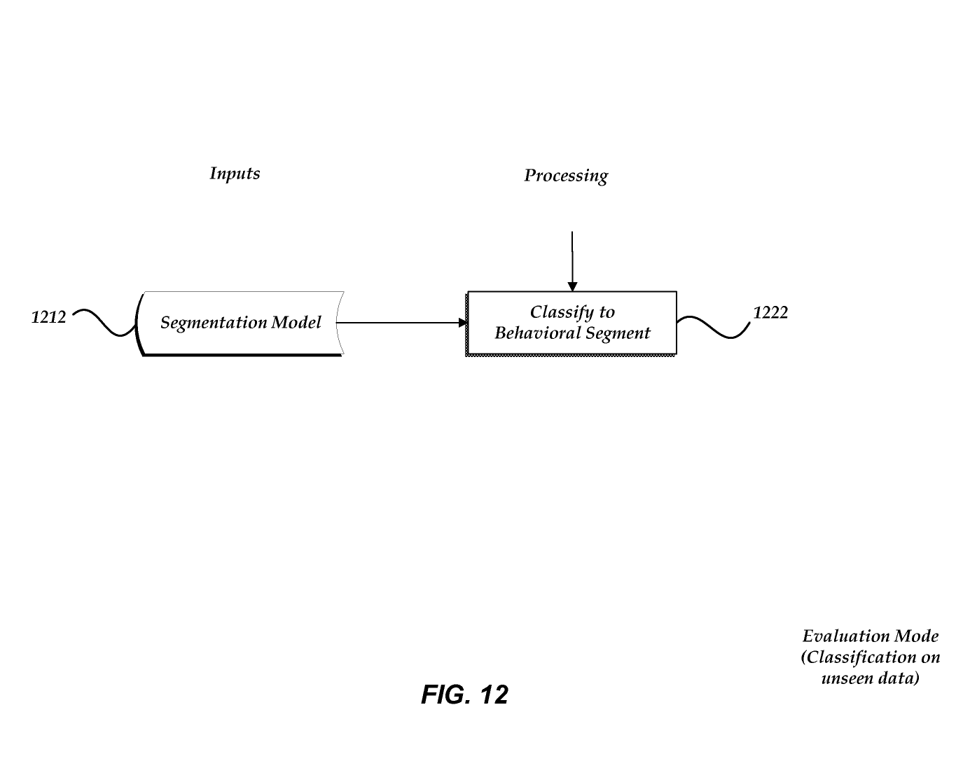

In any event, once a model has been trained, it may be used for scoring unseen customer data. That is, processing flows to block 616, where unseen customer data is received at block 602 and processed at block 604. The evaluation mode is described in more detail below, at least with respect to FIG. 12. Briefly, however, the output of block 604 in the evaluation mode, as in the training mode, is a representation of the customer behavior as a histogram or NMF basis coefficients. Flowing next to block 618 (also discussed further below in conjunction with FIG. 12), the customer data is then classified into one of a plurality of behavioral segments (or clusters).

Continuing next to decision block 620, a determination is made whether to continue performing actions of process 600 on more data. A determination might be positive, for example, where process 600 is first performed using training data, and then performed using unseen customer data. Thus, if processing is to continue for more data, then process 600 branches back to block 602 to receive more data.

Otherwise, if processing of more data is not to continue, then process may return to a calling process. While process 600 is shown in FIG. 6 as returning to a calling process, in other embodiments, process 600 might be re-entered at block 602, a plurality of times, based on a determination to retrain the model, and/or to evaluate additional customer data.

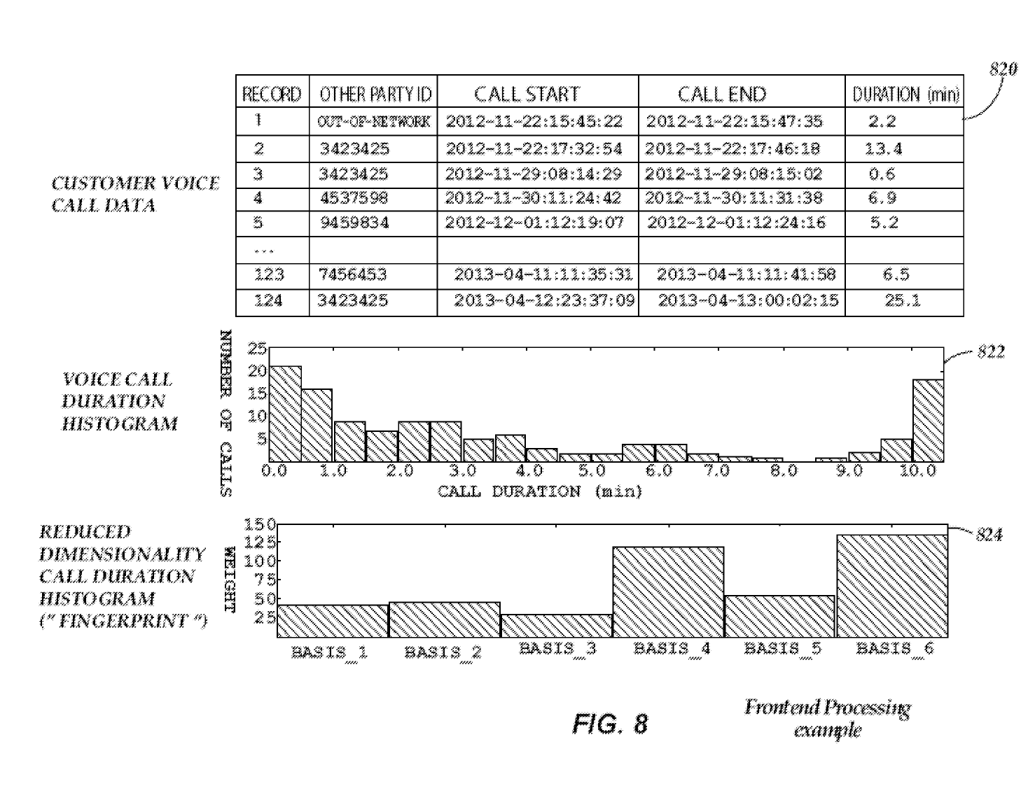

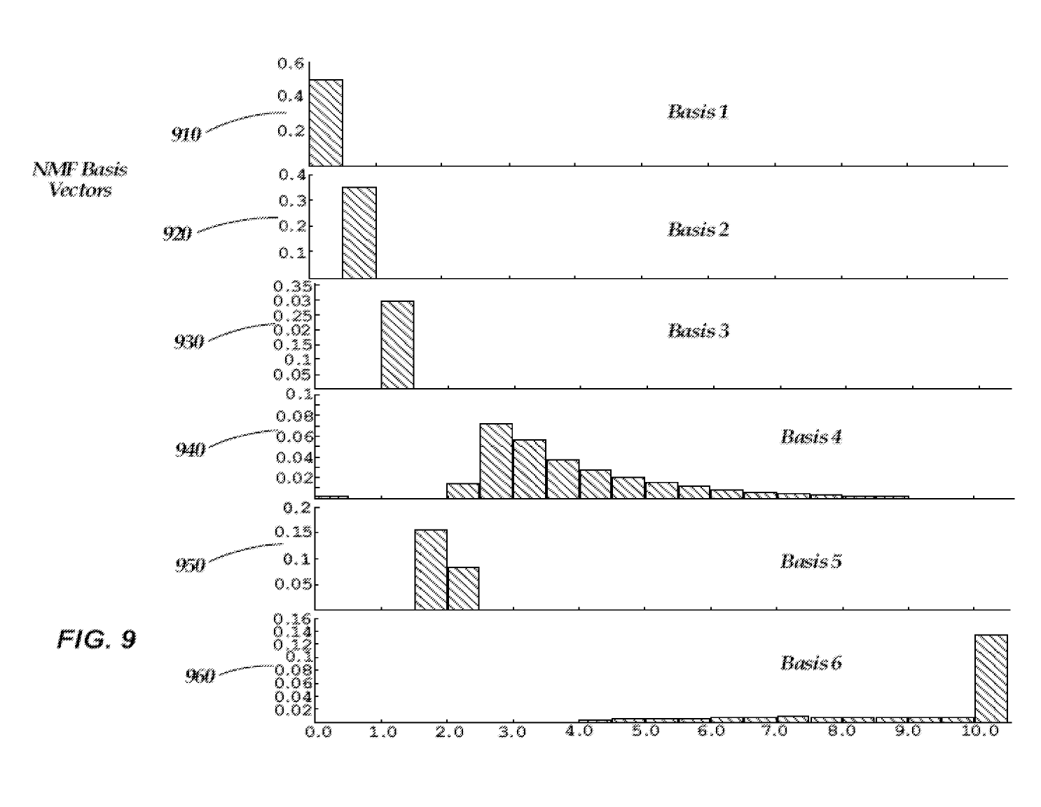

As noted elsewhere, while several sections illustrate telecommunications data, such as FIGS. 8-9, for example, such data are to be understood as examples, and are not limiting, or exhaustive. Rather, they are merely provided to assist in understanding of the embodiments disclosed herein.

Further, at least some figures include one or more sections that are identified as “optional.” As such, it should be understood that such sections might not be performed in some embodiments.

In addition, it will be understood that each block of the flowcharts, and combinations of blocks in the flowcharts, can be implemented by computer program instructions. These program instructions may be provided to a processor to produce a machine, such that the instructions, which execute on the processor, create means for implementing the actions specified in the block or blocks. The computer program instructions may be executed by a processor to cause a series of operational steps to be performed by the processor to produce a computer-implemented process such that the instructions, which execute on the processor to provide steps for implementing the actions specified in the block or blocks. The computer program instructions may also cause at least some of the operational steps shown in the blocks to be performed in parallel. Moreover, some of the steps may also be performed across more than one processor, such as might arise in a multiprocessor computer system. In addition, one or more blocks or combinations of blocks in the illustration may also be performed concurrently with other blocks or combinations of blocks, or even in a different sequence than illustrated without departing from the scope or spirit of the subject innovation.

Accordingly, blocks of the illustration support combinations of means for performing the specified actions, combinations of steps for performing the specified actions and program instruction means for performing the specified actions. It will also be understood that each block of the illustration, and combinations of blocks in the illustration, can be implemented by special purpose hardware based systems, which perform the specified actions or steps, or combinations of special purpose hardware and computer instructions.

### Illustrated Non-Limiting, Non-Exhaustive Examples

The following provides non-limiting, non-exhaustive examples of how various embodiments might be employed to provide contextual offerings to a customer according to the usage histogram-based entity classification disclosed herein. It should be noted that the following examples are not to be construed as limiting the scope of the subject innovation. Rather, they are merely provided to illustrate non-limiting examples of possible uses of the subject innovation. Furthermore, the examples presented are not exhaustive examples.

As discussed above, FIG. 7 illustrates a process flow of one embodiment of the frontend processing module (block 604 shown in FIG. 6), which is common to both the training and evaluation modes. FIG. 7 is an illustrative example of one embodiment of the frontend processing applied to telecommunications data. FIGS. 6 and 7 may be viewed in conjunction with each other, with FIG. 6 illustrating a process flow and FIG. 7 providing one non-limiting, non-exhaustive example. Neither FIG. 6 nor FIG. 7 should be construed as limiting the scope of the subject innovation, but rather as aids in understanding the presented embodiment.

As discussed above in conjunction with FIG. 6, raw customer data 710 (of FIG. 7) records customer activity data. The raw customer data may contain a multiplicity of records of the activity of multiple customers within a time window. In different embodiments, the time window can be static, it can grow dynamically, or it can be a moving window of fixed or variable length. The raw data is ingested in block 720 of FIG. 7 where the usage data pertaining to a particular type of customer activity may be extracted and represented in a form suitable for further processing.

In block 722, the usage data is aggregated into a histogram. The bins of the histogram can represent any partition or multiple partitions of chosen characteristics of the recorded activity. The vector elements composing a histogram (also referred to herein as a fingerprint) may be event counts, summations of activity data, or averages of entity attributes. This list is not exhaustive. In some embodiments, the values may be normalized by entity or otherwise scaled by factors inherent to the dataset, while in other embodiments, there may be no scaling or normalization. In all embodiments, the histogram or fingerprint represents the customer's usage pattern over a time window, which provides a richer expression of the customer's behavior than simple averages.

In some embodiments, the dimensionality of the histogram may be reduced using dimensionality reduction techniques. For some fingerprints, not all bins are equally important for representing the diversity of customers' behaviors. In other cases, dimensionality reduction techniques significantly reduce the computational burden without sacrificing performance. Some embodiments reduce the number of bins in the histogram using principal components analysis. Yet other embodiments use matrix factorization techniques.

An illustrative example of data extraction is provided to aid in comprehension of the subject innovation. In an embodiment, relevant to the field of telecommunications, the particular type of customer activity that is of interest may be the duration of voice calls. In this embodiment, block 720 extracts records of voice calls in the raw data in a specified time window and, in particular, the length of each call is extracted. This is illustrated in table 820 of FIG. 8, which shows a fictitious but representative customer's voice call records.

A histogram of voice call durations is aggregated as illustrated in histogram 822 of FIG. 8, which corresponds to processing block 722 of FIG. 7. In one embodiment, the bins of the histogram are call durations in minutes using the bin ranges: [0,0.5), [0.5,1), [1,1.5), [1.5,2), [2,2.5), [2.5,3), [3,3.5), [3.5,4), [4,4.5), [4.5,5), [5,5.5), [5.5,6), [6,6.5), [6.5,7), [7,7.5), [7.5,8), [8,8.5), [8.5,9), [9.9.5), [9.5,10), and [10,∞). The ordinate of the histogram is number of calls.

In the embodiment shown in FIG. 8, non-negative matrix factorization (NMF) has been used to reduce the dimensionality of the histogram as shown in block 724. Briefly, NMF is a dimensionality reduction technique that discovers a user-specified number of basis vectors based on the training data presented to the algorithm. Each basis vector represents, in this case, a histogram or fingerprint. After discovering the basis vectors, NMF represents any arbitrary vector as a non-negative linear combination of the basis vectors that approximates the original vector. Thus, the dimensionality is reduced from the original number of histogram bins to the number of basis vectors. Histogram 824 of FIG. 8 depicts the coefficients of the linear combination of basis vectors that approximates histogram 822. The six NMF basis vectors are shown in FIG. 9. The example shown in FIGS. 8 and 9 is offered as a concrete illustration of the subject innovation, and is not intended to limit the scope of the invention in any way. The NMF basis vectors shown in FIG. 9 are specific to this example and would be different for different embodiments of the invention and different data sets.

Furthermore, other embodiments employ usage-based histograms that characterize the behavior of entities using different characteristics of their recorded activity. Another non-limiting example is now provided to illustrate one of these alternative embodiments. In one embodiment, the entity is a telecommunications customer, and the bins of the histogram are day-of-week/hour intervals, e.g. bin 1 encodes the number of calls the customer made on Mondays between 00:00:00 AM and 00:59:59 AM over the time window, bin 2 encodes number of calls the customer made on Mondays between 9:00:00 AM to 9:59:59 AM over the time window, and so forth until bin 168 that encodes the number of calls made on Sundays between 11:00:00 PM and 11:59:59 PM over the time window. In this embodiment, the histogram is called the customer's week-hour fingerprint.

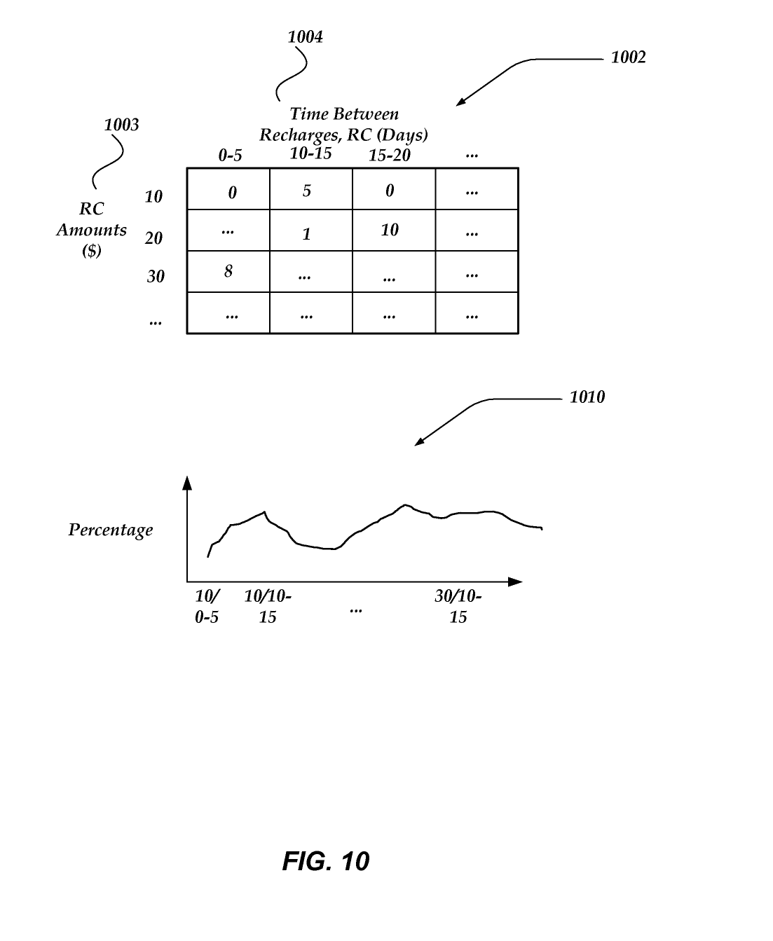

FIG. 10 illustrates a non-limiting, non-exhaustive example of dimensionality reduction for selective customer data. As shown in table 1002 of this example, recharge amounts 1003 may be one dimension, while time between recharges 1004 may represent another dimension of recharge data. Using techniques as discussed above, chart 1010 may then be a resulting output that is directed towards reducing the dimensionality of the recharge data.

Moreover, FIG. 10 illustrates data that can also be aggregated into a histogram chart where histogram bins might represent any partition or multiple partitions encompassing multiple dimensions of the recorded activity.

Returning to FIG. 6, the training of the behavioral classification model is described in more detail in conjunction with FIG. 11. Typically, the amount of time used to train the model scales super-linearly with the number of patterns used for training To avoid long training times, the number of training patterns N is chosen judiciously. Thus, the first step of the training process is the selection of the optimal number of training samples, which is shown as block 1120 in FIG. 11. The following notation is used: Xₜᵣₙ refers to the training set, and Xₜₛₜ refers to the testing set. Under this notation, =|Xₜᵣₙ|. A cross-validation technique may be used to select the minimum number of training patterns. A model trained on too few patterns may be overfit when applied to out-of-sample data (i.e. the testing set). In other words, in an overfit situation the log-likelihood of the training data per sample may exceed the log-likelihood of the testing data per sample. Viewed as a function of the size of the training set, these likelihoods may tend to converge as N increases. Using more training samples than is necessary may increase the computational load with only marginal improvement in generalization performance. One non-limiting non-exhaustive example of selecting a number of training patterns is described in more detail in U.S. patent application, Ser. No. 13/830,957 filed Sep. 12, 2012, entitled “Time-Series Based Entity Behavior Classification,” and which is incorporated herein by reference in its entirety. However, other methods may also be employed.

The next step in the training process is to sample from among the available customer patterns to select the training set. This is shown as block 1122 in FIG. 11. In addition to the usage fingerprint that is being used to segment customers into behaviorally similar segments, there are also static attributes that characterize customers. The customers in the training set for the behavioral segmentation model may be chosen so that they have a similar frequency distribution on one or more of the static attributes as the entire set of customers. This is directed towards ensuring that the customers in the training set are in some sense representative of the entire population of customers. The selection is made on the basis of proportional sampling according to the frequency distribution of one or more static attributes.

One aspect of unsupervised clustering is choosing the number of clusters, which is shown as block 1126 of FIG. 11. This is a difficult task because it is not a well-posed problem. A number of heuristic solutions have been proposed in the machine learning literature, including, for example, U.S. patent application Ser. No. 13/830,957.

In one embodiment, the number of clusters is entirely determined by the number of basis vectors in the NMF decomposition of the training set. In this embodiment, each NMF basis vector is treated as a cluster representative. A pattern is assigned to the cluster which has the largest coefficient in the NMF linear combination that approximates that pattern. As an illustration of this method, the pattern shown in histogram 822 of FIG. 8 would be assigned to Cluster 6 because the coefficient of basis vector 6 is the largest in the NMF representation, histogram 824 of FIG. 8. Note that this pattern also has significant contribution from basis vector 4, as well as some contributions from the other basis vectors. In this embodiment, no further clustering would be performed.

The last step of the training stage is to perform the unsupervised clustering, which is shown as block 1128 in FIG. 11. There are a variety of clustering techniques available. One embodiment of the current subject innovation employs a k-means clustering technique. The k-means clustering technique computes a cluster center μₖ for each of k=1, . . . , K clusters.

A different embodiment employs model-based clustering. Next is described an embodiment that employs a model-based clustering technique in the form of a Gaussian mixture model, as this is the preferred embodiment. The Gaussian mixture model technique models the training patterns as a mixture of K Gaussian components. Each component may be modeled as a multivariate Gaussian with its own mean and covariance matrix. The computation proceeds via an iterative algorithm that alternates between an expectation step, where the likelihood of membership of each pattern to each cluster (component) is computed, and a maximization step, where the parameters for each cluster are computed based on maximizing the likelihood function. This is the classic expectation-maximization algorithm, often simply abbreviated as EM. The end result of applying the EM algorithm to the Gaussian mixture model clustering is the set of parameters that define each cluster. Namely, for clusters k=1, . . . , K, the EM algorithm computes a mean vector μₖ, a covariance matrix Σₖ, and a component fraction Pₖ. Together, these define the Segmentation Model illustrated as block 1138 of FIG. 11.

In the Evaluation Mode of FIG. 6, an input pattern of customer data is subjected to the same frontend processing as has been described previously in relation to the training of the Segmentation Model. The output of the frontend processing is a representation of the customer behavior consisting of a usage-based histogram or NMF fingerprint as illustrated in histogram 822 or 824 of FIG. 8. The goal of Evaluation Mode is to classify the customer into one of the K behavioral segments that were established during the Training Mode. The flow diagram for the Evaluation Mode of the process of FIG. 6 is shown in FIG. 12.

The first step of Evaluation Mode, classification, is shown as block 1222 of FIG. 12. In the embodiment that employs a k-means clustering technique, the classification is carried out by classifying the current customer to the cluster which has the closest cluster center μₖ (in the usage histogram or the NMF fingerprint space). That is, if x is the reduced dimensionality usage histogram representation for the current customer, and C is the cluster to which it is assigned,

$$C = {arg min}_{k = 1 , … , K} {‖ x - {μ}_{k} ‖}^{2}$$

For the embodiment that employs model-based clustering, the posterior probability of the current customer's behavior pattern is used for the classification. That is, for the Gaussian mixture model embodiment,

$$C = {arg max}_{k = 1 , … , K} {P}_{k} P ( x \vert C = k )$$

where P(x|C=k) is the multivariate normal model distribution given by

$$P ( x \vert C = k ) = {( 2 π )}^{- d / 2} {( det {\sum }_{k}^{ } )}^{- 1 / 2} exp [ - \frac{1}{2} {( x - {μ}_{k} )}^{T} {\sum }_{k}^{- 1} ( x - {μ}_{k} ) ]$$

and where d is the dimensionality of the spectral coefficient representation. In the embodiment where there is no aggregation, d=M+1.

FIG. 13 illustrates a non-limiting, non-exhaustive example of employing the usage histogram-based behavioral segmentation to telecommunications data, specifically the duration of outbound calls by a customer. Six distinct patterns of behavior emerge from the unsupervised clustering. The six plots shown in FIG. 13 show the usage histogram for the average of all customers in each cluster. These clusters have been labeled “Medium calls”, “Short and medium calls”, “Short and long calls”, “Mostly short calls”, ‘Shortest calls”, “Mostly long calls”, as these labels are descriptive of the patterns of usage seen in the plots of FIG. 13.

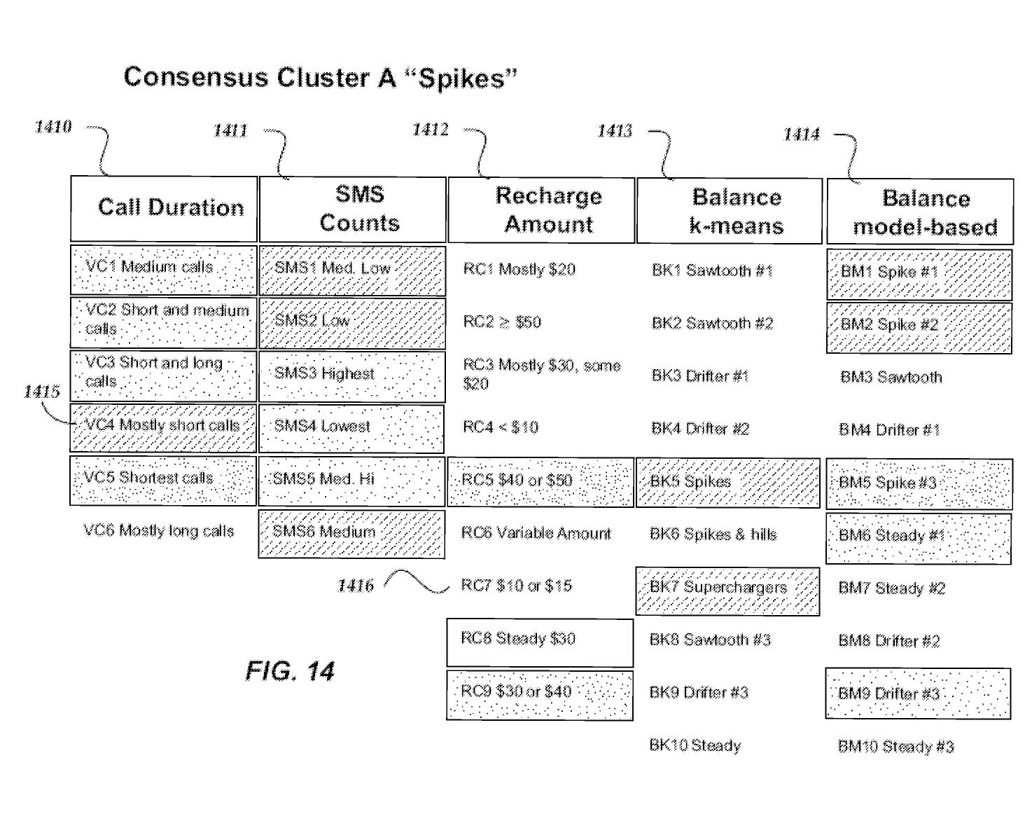

FIG. 14 illustrates a non-limiting, non-exhaustive example of employing the combination of segmentation results from ensemble clusterings as performed at block 512 of FIG. 5, using one or more clustering results from blocks 508, and optionally customer data from block 502 of FIG. 5. As shown, in FIG. 14, columns 1410, 1411, 1412, 1413 and 1414 represent 5 different underlying clusterings, including 2 usage histogram base clusterings as illustrated in FIG. 13. That is, each column 1410-1414 may represent different outputs from blocks 508 of FIG. 5.

Column 1410 is based on voice call duration and 1411 is based on SMS counts. 1412 reflects a similar histogram-based clustering based on Recharge Amount, while columns 1413 and 1414 reflect 2 different clusterings employing a time series-based behavioral classification.

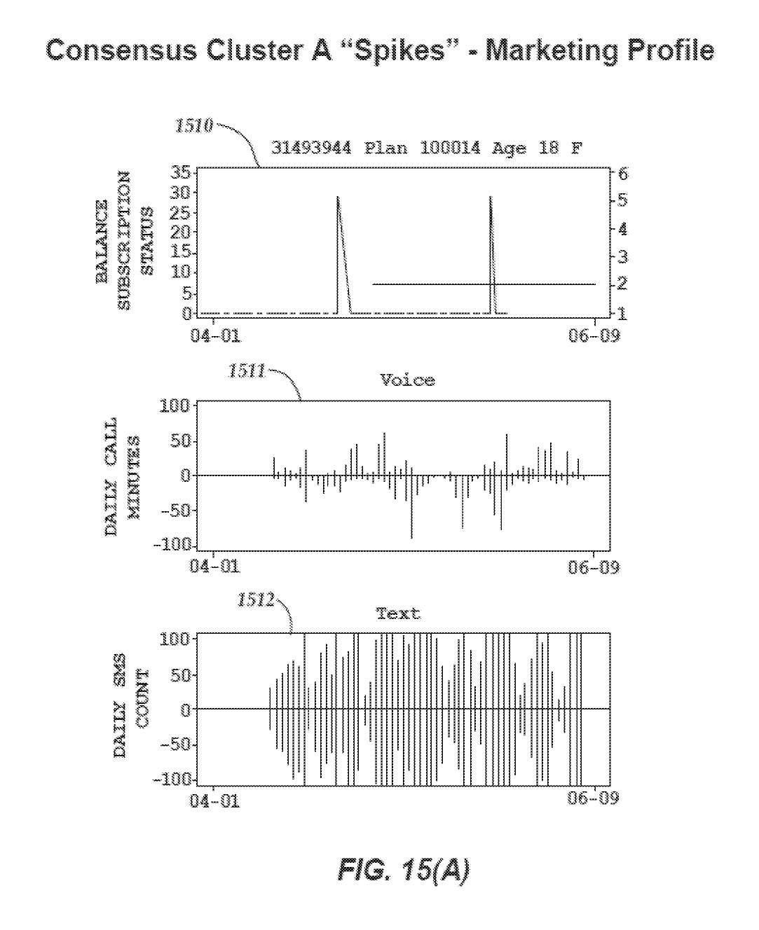

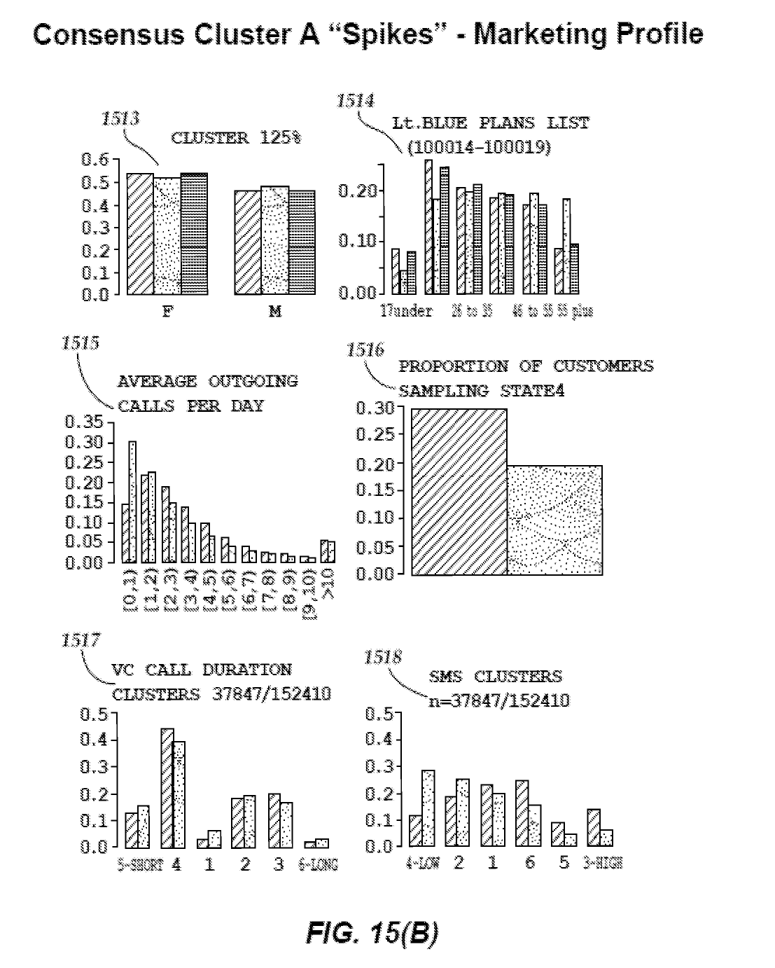

FIGS. 15A-15B illustrates a non-limiting, non-exhaustive example of employing the usage histogram-based behavioral analysis with other behavioral elements as part of a consensus clustering (ensemble clustering) to dynamically market offerings to the behavioral segment shown in FIG. 14. The “Spikes” cluster of FIG. 15A consists predominantly of customers exhibiting a balance time series that has spikes of balance as shown in chart 1510 of FIG. 15A, for a representative customer. Their inbound (above the axis) and outbound (below the axis) Voice and Text (SMS) activity are moderate and heavy as show in 1511 and 1512, respectively. The static attributes of this cluster also have a distinct profile, compared to the overall customer population by comparing the first and second bars of each of the charts 1513-1518 (of FIG. 15B) representing the average distributions of many attributes for members of this cluster, and for the entire customer population: these customers tend to be skewed to younger age groups: 17 and under, 18-25 (1514) with a slight bias for females (1513), an emphasis on rate plans without rollover, higher than average voice usage (1515,1517), heavy SMS usage (1518), lower than average spend, high proportion of customers with de-active (“State 4”) episodes in which the customer can receive incoming calls/texts only (1516). Such marketing elements may be shown in an automated user interface; however, other mechanisms of visualizing the elements may also be used. The marketing goal for this cluster would be to increase recharge frequency, use offers that enable sustained outbound activity in the context of inbound activity while in inactive status. Again, it should be understood that these are merely examples of how the time series-based behavioral classification might be used to dynamically market to a customer.

As noted in FIG. 5, a threshold value may be applied to the data illustrated to determine whether to provide an offering at a given time and location to a customer. In some embodiments, no offering is determined to have a likelihood of being accepted by the customer above the threshold for the given time and location. Therefore, in some embodiment, no offer might be sent to a customer.

The above specification, examples, and data provide a complete description of the manufacture and use of the composition of the subject innovation. Since many embodiments of the subject innovation can be made without departing from the spirit and scope of the subject innovation, the subject innovation resides in the claims hereinafter appended.

What is claimed as new and desired to be protected by Letters Patent of the United States is:

1. A network device, comprising:
a transceiver to send and receive data over a network; and
a processor that performs actions, comprising:
receiving telecommunications customer data for a plurality of customers;
extracting from the customer data a usage histogram for each of the plurality of customers;
computing for each of the plurality of customers, a reduced dimensionality usage histogram from the extracted usage histograms;
performing a clustering from the reduced dimensionality usage histograms to generate a plurality of clusters; and
classifying each customer time series within one of the plurality of clusters, the classifications selectively usable to dynamically market to a customer identified by a cluster.

2. The network device of claim 1, wherein for each of the plurality of customers the processor performs actions, further comprising:
combining the cluster classification from the usage histogram content with cluster classifications from other clustering solutions;
performing a consensus clustering of the combined cluster classifications;
classifying each customer with the consensus cluster assignment, the classifications usable to dynamically market to at least one customer identified by the consensus cluster.

3. The network device of claim 2, wherein combining the cluster classifications further comprises combining the cluster classifications with at least some of the received telecommunications customer data prior to performing the consensus clutering.

4. The network device of claim 1, wherein the clusters being selectively usable to dynamically market to a customer identified by a cluster, further comprises:
employing a threshold value that is applied to data within a cluster to determine whether to provide an offering at a given time or location to a given customer; and
when it is determined that the offering has a likelihood of not being accepted by the given customer based on the threshold for the given time and location, then inhibiting sending of the offering to the given customer; and otherwise,
sending the offering to the given customer at the given time or location.

5. The network device of claim 1, wherein performing a clustering from the reduced dimensionality usage histogram to generate a plurality of clusters, further comprising:
determining a number of clusters to generate in the plurality of clusters using a statistical measure of an othogonality of data types within the telecommunications customer data for the plurality of customers.

6. The network device of claim 1, wherein the usage histograms are represented using matrix-factorized histogram coefficients.

7. The network device of claim 1, wherein classifying each customer time series is based on training of a behavioral classification model that employs a cross-validation mechanism to select a minimum number of training patterns to satisfy a selected criteria.

8. The network device of claim 1, wherein for each of the plurality of customers the processor performs actions, further comprising:
combining the cluster classification from the usage histogram content with cluster classifications from a defined number of other clustering solutions, the number of clusters that are combined is determined based on a number of basis vectors obtained in a non-negative matrix factorization decomposition of a training set of data.

9. A system, comprising:
one or more non-transitory storage devices usable to store customer data; and
one or more processors that perform actions, comprising:
receiving telecommunications customer data for a plurality of customers;
extracting from the telecommunications customer data a usage histogram for each of the plurality of customers, wherein each histogram includes a customer's usage pattern over a given time window;
computing for each of the plurality of customers, a reduced dimensionality usage histogram from the extracted usage histograms;
performing a clustering from the reduced dimensionality usage histogram to generate a plurality of clusters; and
classifying each customer time series within one of the plurality of clusters, the classifications selectively used to dynamically identify an occasion when to perform an interaction directed towards a customer identified by a cluster.

10. The system of claim 9, wherein computing for each of the plurality of customers, a reduced dimensionality usage histogram includes using a non-negative matrix factorization to generate a number of basis vectors.

11. The system of claim 9, wherein classifying each customer time series is based on training of a behavioral classification model that employs a cross-validation mechanism to select a minimum number of training patterns to satisfy a selected criteria.

12. The system of claim 9, wherein for each of the plurality of customers the one or more processors perform actions, further comprising:
combining the cluster classification from the usage histogram content with cluster classifications from other clustering solutions;
performing a consensus clustering of the combined cluster classifications;
classifying each customer within the consensus cluster assignment, the classifications being used to dynamically market to at least one customer identified by a consensus cluster.

13. The system of claim 12, wherein combining the cluster classifications further comprises combining the cluster classifications with at least some of the received telecommunications customer data prior to performing the consensus clustering.

14. The system of claim 9, wherein at least one of the other clustering solutions is determined using a different clustering technique than that used for determining the cluster classification.

15. The system of claim 9, wherein the clusters being selectively used to dynamically market to a customer identified by a cluster, further comprises:
employing a threshold value that is applied to data within a cluster to determine whether to provide an offering at a given time or location to a given customer; and
when it is determined that the offering has a likelihood of not being accepted by the given customer based on the threshold for the given time and location, then inhibiting sending of the offering to the given customer; and otherwise,
sending the offering to the given customer at the given time or location.

16. The system of claim 9, wherein performing a clustering from the reduced dimensionality usage histogram to generate a plurality of clusters, further comprising:
determining a number of clusters to generate in the plurality of clusters using a statistical measure of an othogonality of data types within the telecommunications customer data for the plurality of customers.

17. An apparatus comprising a non-transitory computer readable medium, having computer-executable instructions stored thereon, that in response to execution by a special purpose computing device, cause the special purpose computing device to perform operations, comprising:
receiving telecommunications customer data for a plurality of customers;
extracting from the telecommunications customer data a usage histogram for each of the plurality of customers, wherein each histogram includes a customer's usage pattern over a given time window;
computing for each of the plurality of customers, a reduced dimensionality usage histogram from the extracted usage histograms;
performing a clustering from the reduced dimensionality usage histogram to generate a plurality of clusters; and
classifying each customer time series within one of the plurality of clusters, the classifications selectively being used to dynamically identify an occasion when to perform an interaction directed towards a customer identified by a cluster.

18. The apparatus of claim 17, wherein for each of the plurality of customers the special purpose computing device to perform operations, further comprising:
combining the cluster classification from the usage histogram content with cluster classifications from other clustering solutions;
performing a consensus clustering of the combined cluster classifications;
classifying each customer with the consensus cluster assignment, the classifications selectively used to dynamically market to at least one customer identified by a consensus cluster.

19. The apparatus of claim 18, wherein combining the cluster classifications further comprises combining the cluster classifications with at least some of the received telecommunications customer data.

20. The apparatus of claim 17, wherein the clusters being selectively used to dynamically market to a customer identified by a cluster, further comprises:
employing a threshold value that is applied to data within a cluster to determine whether to provide an offering at a given time or location to a given customer; and
when it is determined that the offering has a likelihood of not being accepted by the given customer based on the threshold for the given time and location, then inhibiting sending of the offering to the given customer; and otherwise,
sending the offering to the given customer at the given time or location.

21. The apparatus of claim 17, wherein performing a clustering from the reduced dimensionality usage histogram to generate a plurality of clusters, further comprising:
determining a number of clusters to generate in the plurality of clusters using a statistical measure of an othogonality of data types within the telecommunications customer data for the plurality of customers.
